(19) United States
(12) Patent Application Publication
(10) Pub. No.: US 2006/0007824 A1
(43) Pub. Date: Jan. 12, 2006

(54) Disc reproduction device

(75) Inventor: Takako Araki, Osaka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: Sanyo Electric Co., Ltd., Osaka (JP)

(21) Appl. No.: 10/520,280

(22) PCT Filed: Jul. 25, 2003
(86) PCT No.: PCT/JP03/09507

§ 371 Date: Jan. 27, 2005

(30) Foreign Application Priority Data
Jul. 30, 2002 (JP) 2002-220865

(51) Int. Cl. G11B 5/09

(52) U.S. Cl. 369/47.53; 369/53.1; 369/47.5

(57) ABSTRACT

The present invention provides a disk playback device including a laser drive circuit 6 capable of feeding a drive signal to an optical head 5 and adjusting a power of a laser beam irradiated by the optical head 5 and a control circuit 7 for detecting an error rate of a reproduction signal and controlling operation of the laser drive circuit 6. The control circuit 7 repeatedly retrieves one boundary value of two boundary values wherein the error rate is a prescribed value or in the vicinity of the prescribed value and calculates an optimum reproduction power based on the one boundary value retrieved. Here, the control circuit 7 retrieves a new boundary value based on a boundary value obtained by a previous optimum reproduction power calculation.

### TECHNICAL FIELD

The present invention relates to disk playback devices for reproducing signals from a disk by irradiating the disk with a laser beam from an optical head.

### BACKGROUND ART

For use as recording media in disk recording-playback devices, magneto-optical disks have been developed which permit rewriting and have a great memory capacity and high reliability. Such disks have found wide use as external memories in computers and audio visual devices.

Developed especially in recent years are techniques for achieving improved recording densities by forming lands 11 and grooves 12 alternately on a signal bearing surface of a magneto-optical disk 1 as shown in FIG. 8 and recording signals on both the lands 11 and the grooves 12.

The lands 11 and the grooves 12 are wobbled as illustrated, and the wobbling frequency is a predetermined center frequency as frequency-modulated. A wobble signal is detected by signal reproduction, and the rotation of the magneto-optical disk is so adjusted that the wobble signal has the center frequency at all times, whereby constant linear velocity control is realized. Various items of information (wobble information) such as address information are contained in the wobble signal which is frequency-modulated as stated above. Various control operations are realized based on the wobble information at the time of signal reproduction.

With the disk recording-playback device of a laser-pulsed magnetic field modulation type, a laser beam is projected onto the disk for signal reproduction, and a laser beam is also projected onto the disk for signal recording, and the disk is heated locally. Furthermore, with magneto-optical disks using magnetic super resolution, signal reading is started whereupon the temperature in a beam spot region reaches a predetermined value while laser power for signal reproduction is increased. The laser power for signal reproduction (reproduction power) is set lower than the laser power for signal recording (recording power), so that there is no likelihood that the recorded signals are damaged along with signal reproduction.

In signal reproduction of the disk recording-playback device, variations in reproduction power alter error rates of reproduced signals in a quadratic curve, for example, as shown in FIG. 9, so that an optimum reproduction power Prcent wherein an error rate is a minimum value is present. If a reproduction power differs from the optimum value Prcent, an error rate of a reproduced signal increases. If the error rate exceeds a given prescribed value, difficulty is encountered in performing a normal signal reproduction. Similarly in signal recording, an optimum recording power wherein an error rate is a minimum value is present. If the error rate exceeds a given prescribed value, difficulty is encountered in performing a normal signal recording. Therefore, the laser power for signal reproduction needs to be set between two boundary values wherein the error rate is a prescribed value or in the vicinity of the prescribed value, i.e., between a lower boundary reproduction power Prmin and an upper boundary reproduction power Prmax, and the laser power for signal recording needs to be set between two boundary values wherein the error rate is a prescribed value or in the vicinity of the prescribed value, i.e., between a lower boundary recording power and an upper boundary recording power.

Accordingly, with the conventional disk recording-playback device, an optimum reproduction power and recording power each having the lowest error rate are retrieved in the system's initiation into operation.

In a retrieving processing of an optimum reproduction power, as shown in FIG. 12, first a reproduction power is set to an initial value P₀, and then the reproduction power is decreased to thereby be altered to a lower boundary value Prmin₁ wherein the error rate is not more than a given prescribed value (=20). Thereafter a predetermined value N (a power for a predetermined number of steps) is added to the reproduction power to thereby determine an optimum reproduction power P₁.

FIG. 10 shows a procedure for adjusting a reproduction power executed in an initiation into operation of the disk recording-playback device. First in step S51 an initial value P₀ is set as a current reproduction power Pr. In step S52 test tracks are reproduced, and an error rate concerned E is measured. Next in step S53 an inquiry is made as to whether the measured error rate E is greater than a prescribed value E₀ (=20). When the answer is negative, step S54 follows to decrease the reproduction power Pr by four steps. Thereafter the sequence returns to step S52 to repeat the same procedure.

Thereafter when the error rate E exceeds the prescribed value E₀ and the answer for step S53 is affirmative, step S55 follows to increase the reproduction power Pr by one step. Thereafter in step S56 the test tracks are reproduced, and an error rate concerned E′ is measured. Next in step S57 an inquiry is made as to whether the measured error rate E′ is not more than the prescribed value E₀. When the answer is negative, the sequence returns to step S55 to repeat the same procedure.

When the error rate E′ falls not more than the prescribed value E₀ and the answer for step S57 is affirmative, step S58 follows to set the reproduction power concerned Pr to a lower boundary value Prmin. In step S59 a value obtained by adding a power for four steps to the lower boundary reproduction power Prmin is set as an optimum reproduction power Prcent, to terminate the procedure. Consequently, reproduction of signals will be started with an optimum laser power.

However, in a usual operation for signal reproduction and signal recording, a disk temperature is gradually increased by a projection of a laser beam, and an optimum recording power and an optimum reproduction power will be altered, accordingly. Therefore, even if a laser power is an optimum in the system's initiation into operation, the laser power differs from the optimum value thereafter in the usual operation and difficulty is encountered in performing a normal signal recording and signal reproduction.

Accordingly, in the usual operation, a laser power is optimized whenever a disk temperature varies by a predetermined temperature or more.

In a retrieving processing of an optimum reproduction power in the usual operation, as shown in FIG. 13, first a reproduction power is decreased from a currently set value P₁ to thereby be altered to a lower boundary value Prmin₂ wherein the error rate is not more than a given prescribed value (=20). Thereafter a predetermined value N (a power for a predetermined number of steps) is added to the reproduction power to thereby determine an optimum reproduction power P₂.

FIG. 11 shows a procedure for adjusting a reproduction power executed when a temperature varies by a predetermined temperature (=5° C.) or more in the usual operation after the system's initiation into operation. First in step S61 a reproduction power Pr is set as a currently set value. In step S62 test tracks are reproduced, and an error rate concerned E is measured. Next in step S63 an inquiry is made as to whether the measured error rate E is greater than a prescribed value E₀ (=20). When the answer is negative, step S64 follows to decrease the reproduction power Pr by four steps. Thereafter the sequence returns to step S62 to repeat the same procedure.

Thereafter when the error rate E exceeds the prescribed value E₀ and the answer for step S63 is affirmative, step S65 follows to increase the reproduction power Pr by one step. Thereafter in step S66 the test tracks are reproduced, and an error rate concerned E′ is measured. Next in step S67 an inquiry is made as to whether the measured error rate E′ is not more than the prescribed value E₀. When the answer is negative, the sequence returns to step S65 to repeat the same procedure.

When the error rate E′ falls not more than the prescribed value E₀ and the answer for step S67 is affirmative, step S68 follows to set the reproduction power concerned Pr to a lower boundary value Prmin. In step S69 a value obtained by adding a power for four steps to the lower boundary reproduction power Prmin is set as an optimum reproduction power Prcent, to terminate the procedure. Consequently, reproduction and recording of signals will be continued with an optimum laser power according to a temperature of the magneto-optical disk.

However, with the disk recording-playback device described, as shown in FIG. 13, because a reproduction power referred to when the lower boundary value Prmin is retrieved in a reproduction power optimization in the usual operation, i.e., the reproduction power P₁ currently set has a value far from the new lower boundary value Prmin₂, a long period of time is needed for retrieving the new lower boundary value Prmin₂ and the retrieval of an optimum reproduction power takes much time, entailing the problem that there is a likelihood that original reproduction operation and recording operation are affected.

An object of the present invention is to provide a disk playback device capable of determining an optimum laser power in a usual operation in a short period of time.

### DISCLOSURE OF THE INVENTION

A disk playback device of the present invention comprises a laser drive circuit capable of feeding a drive signal to an optical head and adjusting a power of a laser beam irradiated by the optical head and a control circuit for controlling operation of the laser drive circuit. The control circuit comprises reproduction power optimizing means for repeatedly optimizing the power of the laser beam for signal reproduction. The reproduction power optimizing means comprises:

evaluation data detecting means for detecting evaluation data representing quality of a signal reproduction state;

retrieving means for retrieving one boundary value of two boundary values of a reproduction power wherein the evaluation data is a prescribed value or in the vicinity of the prescribed value; and

optimum reproduction power calculating means for calculating an optimum reproduction power based on the retrieved one boundary value,

and the retrieving means retrieves a new boundary value based on a boundary value obtained by a previous optimizing processing.

Usable as the evaluation data is, for example, a frequency of occurrence of bit errors (bit error rate) included in a reproduced signal.

In a reproduction power optimization of the present invention, a new boundary value is retrieved based on a boundary value retrieved by a previous optimizing processing. Here, the boundary value retrieved by the previous optimizing processing is a closer value to the new boundary value than a currently set reproduction power. Therefore, a period of time needed for the retrieval of the boundary value is shortened, whereby a period of time taken for a calculation of an optimum reproduction power is shortened.

Stated specifically, the retrieving means retrieves a lower boundary value having a smaller value from the two boundary values, and the optimum reproduction power calculating means adds a predetermined value to the lower boundary value to thereby determine the optimum reproduction power.

The relationship between a reproduction power and an error rate can be represented in a quadratic curve, and a laser power corresponding to a lowest point of the quadratic curve is an optimum reproduction power that minimizes the error rate. Furthermore, as an optimum value of a reproduction power varies, a lower boundary value also varies, so that a difference between the optimum value and the lower boundary value is an approximately constant value. Therefore, when a lower boundary value is obtained, an optimum reproduction power can be determined by adding this difference to the lower boundary value.

Stated further specifically, the disk playback device comprises temperature detecting means for detecting a temperature of the disk, and the reproduction power optimizing means optimizes the reproduction power whenever the temperature of the disk varies by a predetermined temperature.

In the above specific construction, an optimum reproduction power according to a temperature of the disk is obtained whenever the temperature of the disk varies by a predetermined temperature, so that the power of the laser beam irradiated by the optical head is adjusted to an optimum value. Consequently, the bit error rate for signal reproduction is minimized, so that there is no likelihood that recorded signals are damaged along with signal reproduction.

As described above, with the disk playback device of the present invention, an optimum laser power can be determined in a short period of time in the usual operation.

### BRIEF DESCRIPTION OF THE DRAWINGS

FIG. 1 is a block diagram showing a construction of a disk recording-playback device embodying the present invention.

FIG. 2 is a flow chart showing a procedure executed in an initiation into operation of the above disk recording-playback device.

FIG. 3 is a flow chart showing a specific procedure for a reproduction power adjustment processing executed in the initiation into operation.

FIG. 4 is a flow chart showing a procedure executed in a usual operation of the above disk recording-playback device.

FIG. 5 is a flow chart showing a specific procedure for a reproduction power adjustment processing executed in the usual operation.

FIG. 6 is a graph illustrating a process for the reproduction power adjustment processing executed in the initiation into operation of the above disk recording-playback device.

FIG. 7 is a graph illustrating a process for the reproduction power adjustment processing executed in the usual operation of the above disk recording-playback device.

FIG. 8 is an enlarged perspective view showing lands and grooves formed on a magneto-optical disk.

FIG. 9 is a graph showing the relationship between a reproduction power and an error rate.

FIG. 10 is a flow chart showing a specific procedure for a reproduction power adjustment processing executed in an initiation into operation in a conventional disk recording-playback device.

FIG. 11 is a flow chart showing a specific procedure for a reproduction power adjustment processing executed in a usual operation in the above disk recording-playback device.

FIG. 12 is a graph illustrating a process for the reproduction power adjustment processing executed in the initiation into operation of the above disk recording-playback device.

FIG. 13 is a graph illustrating a process for the reproduction power adjustment processing executed in the usual operation of the above disk recording-playback device.

### BEST MODE OF CARRYING OUT THE INVENTION

With reference to the drawings, a detailed description will be given below of the present invention as embodied into disk recording-playback devices for use with magneto-optical disks serving as recording media.

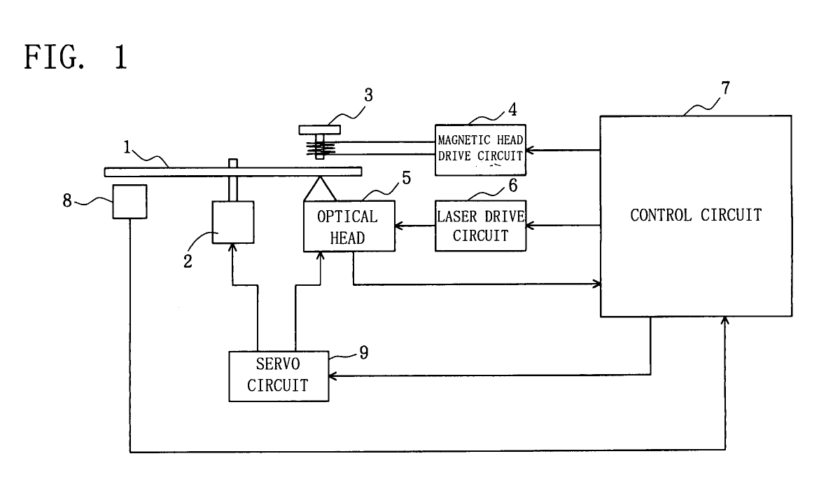

FIG. 1 shows a disk recording-playback device embodying the invention and comprising a spindle motor 2 for rotatingly driving a magneto-optical disk 1, a magnetic head 3 and an optical head 5 provided above and below the magneto-optical disk 1, respectively. A magnetic head drive circuit 4 is connected to the magnetic head 3 while a laser drive circuit 6 is connected to the optical head 5. Connected to the magnetic head drive circuit 4 and the laser drive circuit 6 is a control circuit 7, which controls recording/reproduction operations of signals. An output signal of the optical head 5 is fed to the control circuit 7, and output to a subsequent circuit as reproduced data after processing such as amplification, detection of reproduction signals, and error correction.

Further, a servo circuit 9 is connected to the spindle motor 2 and the optical head 5. A focus error (FE) signal and a tracking error (TE) signal obtained from the output signal of the optical head 5 are fed to the servo circuit 9 from the control circuit 7. In response to the FE signal and TE signal, focusing servo and tracking servo for an actuator (not shown) provided for the optical head 5 are executed. Furthermore, an external synchronizing signal is fed to the servo circuit 9 from the control circuit 7, and the rotation of the spindle motor 2 is controlled based on the signal.

Furthermore, provided as opposed to the magneto-optical disk 1 is a temperature sensor 8 for measuring a temperature of the magneto-optical disk 1. An output terminal of the temperature sensor 8 is connected to the control circuit 7, where a laser power control signal is prepared based on temperature data obtained from the temperature sensor 8. The prepared signal is fed to the laser drive circuit 6, where a power of a laser beam irradiated by the optical head 5 for signal reproduction and signal recording in response to the laser power control signal is adjusted, as will be described below.

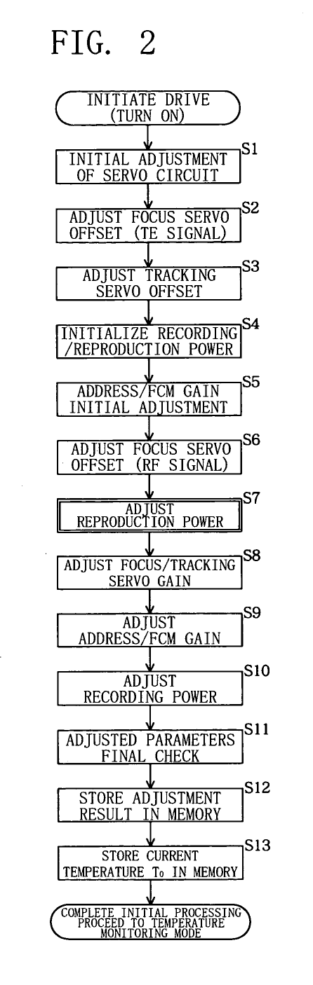

FIG. 2 shows a procedure executed by the control circuit 7 in an initiation into operation of the disk recording-playback device. When the device is turned on, first in step S1 various gains of the servo circuit 9 are set to initial values. In step S2 an offset value for focus is adjusted based on the TE signal.

Next in step S3 an offset value for tracking is adjusted based on the TE signal, and thereafter in step S4 each of a recording power and reproduction power is set to an initial value. Then in step S5 a gain necessary for reading out address information recorded on the magneto-optical disk (address gain) and a gain necessary for reading out an FCM (fine clock mark) are set to initial values.

Subsequently in step S6 the offset value for focus is adjusted based on the RF signal, and thereafter in step S7 the reproduction power is adjusted. Then in step S8 a servo gain for focus and a servo gain for tracking are adjusted, and thereafter in step S9 the address gain and FCM gain are adjusted. A series of the adjustment processing of step S6 to step S9 is executed for each of the lands and grooves of the test tracks pre-provided on the magneto-optical disk.

Then in step S10 the recording power is adjusted for each of the lands and grooves of the test tracks. In step S11 current values of parameters adjusted as described are checked. Finally in step S12 the current values of those parameters are stored in a built-in memory, and thereafter in step S13 a current disk temperature To is stored in the built-in memory to terminate the procedure.

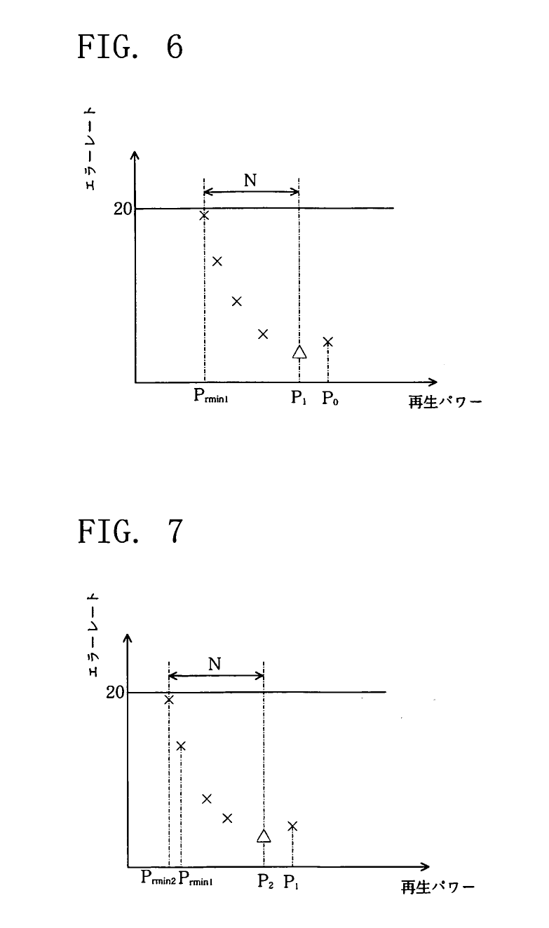

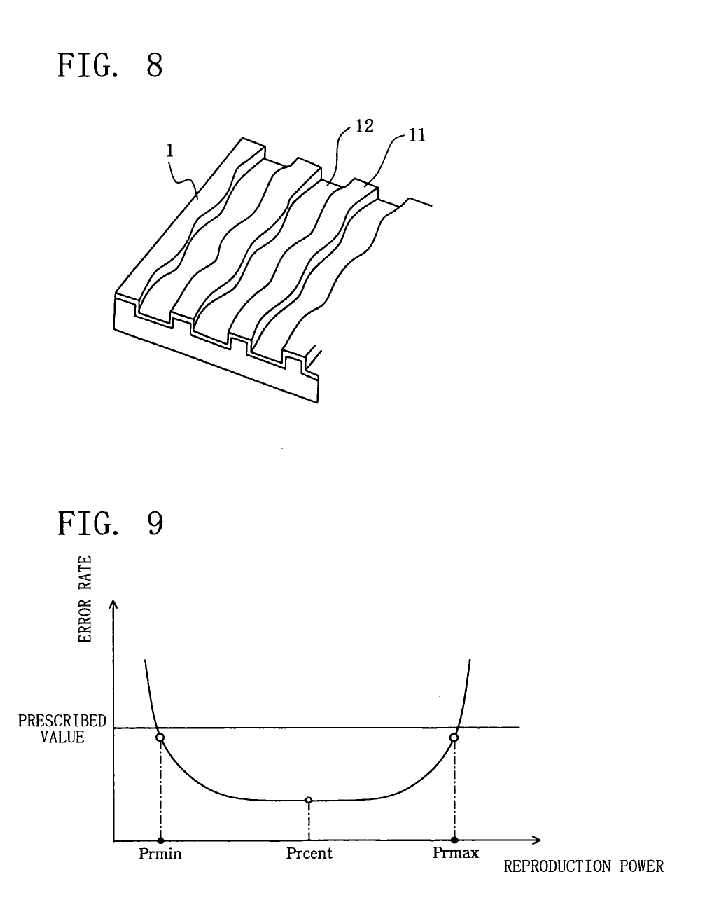

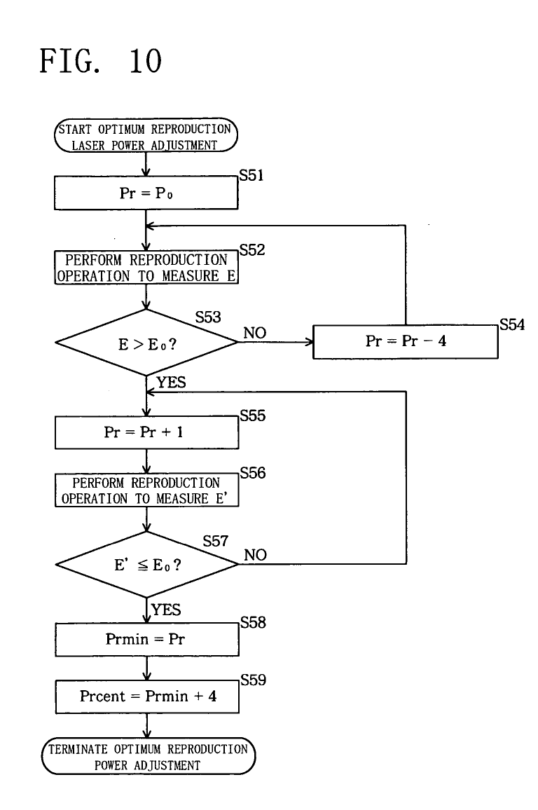

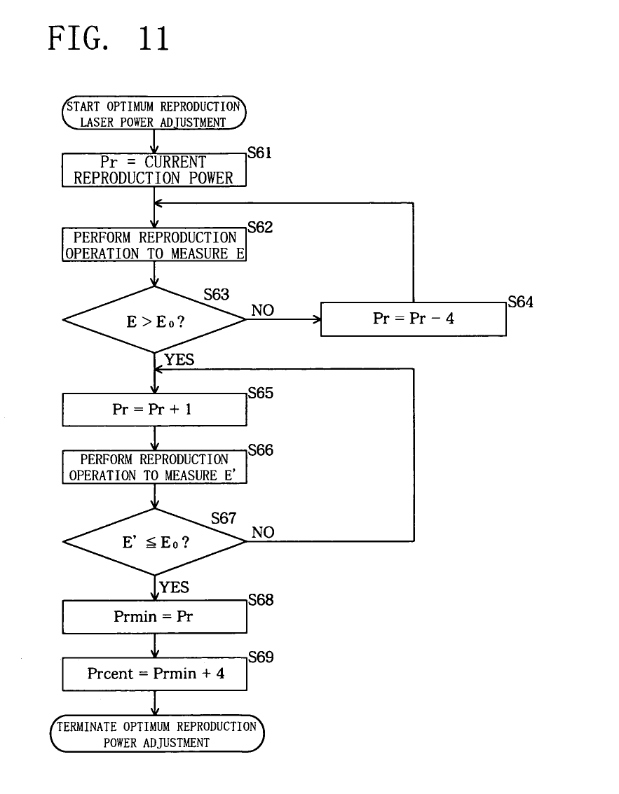

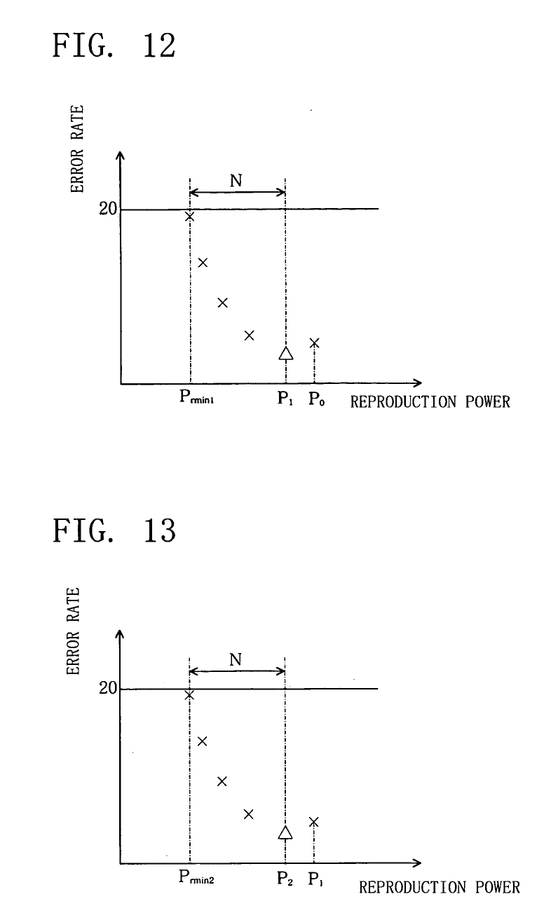

In the reproduction power adjustment processing of step S7 described above, as shown in FIG. 6, first a reproduction power is set to an initial value P₀, and then the reproduction power is decreased to thereby be altered to a lower boundary value Prmin₁ wherein the error rate is not more than a given prescribed value (=20). Thereafter a predetermined value N (a power for a predetermined number of steps) is added to the reproduction power to thereby determine an optimum reproduction power P₁. This process is the same as the reproduction power adjustment processing executed in the initiation into operation of the conventional disk recording-playback device.

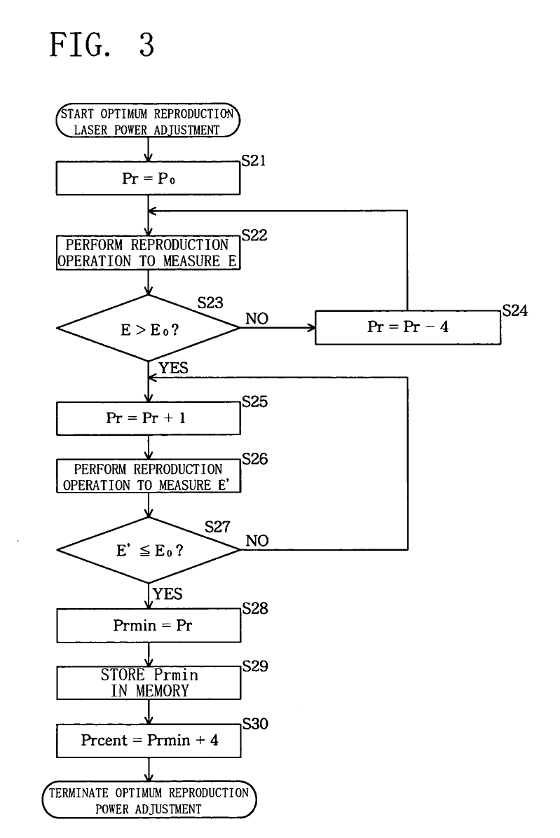

FIG. 3 shows a specific procedure for the reproduction power adjustment processing executed in step S7 described above. First in step S21 an initial value P₀ is set as a current reproduction power Pr. In step S22 test tracks are reproduced, and an error rate concerned E is measured. Next in step S23 an inquiry is made as to whether the measured error rate E is greater than a prescribed value E₀ (=20). When the answer is negative, step S24 follows to decrease the reproduction power Pr by four steps. Thereafter the sequence returns to step S22 to repeat the same procedure.

Thereafter when the error rate E exceeds the prescribed value E₀ and the answer for step S23 is affirmative, step S25 follows to increase the reproduction power Pr by one step. Thereafter in step S26 the test tracks are reproduced, and an error rate concerned E′ is measured. Next in step S27 an inquiry is made as to whether the measured error rate E′ is not more than the prescribed value E₀. When the answer is negative, the sequence returns to step S25 to repeat the same procedure.

When the error rate E′ falls not more than the prescribed value E₀ and the answer for step S27 is affirmative, step S28 follows to set the reproduction power concerned Pr to a lower boundary value Prmin. In step S29 the lower boundary value Prmin is stored in a built-in memory, and thereafter in step S30 a value obtained by adding a power for four steps to the lower boundary value Prmin is set as an optimum reproduction power Prcent, to terminate the procedure. Consequently, reproduction and recording of signals will be started with an optimum laser power.

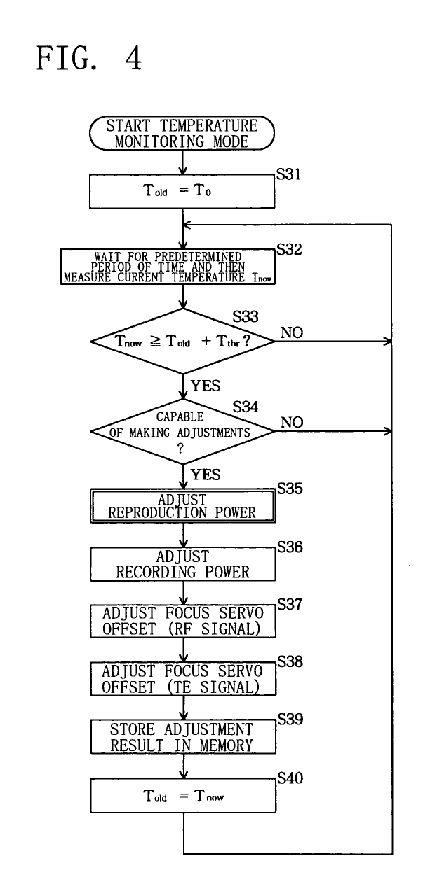

FIG. 4 shows a procedure executed by the control circuit 7 in a usual operation for signal reproduction and signal recording after the system's initiation into operation. When the usual operation is started, first in step S31 a past disk temperature T_{old} is set to a temperature T₀ stored in the built-in memory in the initiation into operation of the device as described. In step S32 after a wait for a predetermined period of time a current disk temperature T_{now} is measured.

Subsequently in step S33 an inquiry is made as to whether the current disk temperature T_{now} is not less than a temperature obtained by adding the past disk temperature T_{old} to a predetermined temperature Tₜₕᵣ (T_{old}+Tₜₕᵣ). When the answer is negative, the sequence returns to step S32 to repeat the same procedure. Here, the predetermined temperature Tₜₕᵣ is set to 5° C., for example.

When a disk temperature varies by the predetermined temperature Tₜₕᵣ or more and the answer for step S33 is affirmative, the sequence proceeds to step S34 wherein an inquiry is made as to whether the device is set capable of adjusting various parameters according to temperature variations of the disk. When the answer is negative, the sequence returns to step S32. On the other hand, when the answer is affirmative, step S35 follows to adjust the reproduction power, and thereafter in step S36 the recording power is adjusted.

Then in step S37 the offset value for focus is adjusted based on the RF signal, and thereafter in step S38 the offset value for focus is adjusted based on the TE signal. Finally in step S39 current values of parameters adjusted as described are stored in the built-in memory, and thereafter in step S40 the past disk temperature T_{old} is set to the current disk temperature T_{now}. Then the sequence returns to step S32.

In the reproduction power adjustment processing of step S35 described above, as shown in FIG. 7, first a reproduction power is decreased from a lower boundary value Prmin₁ obtained by the previous adjustment processing to thereby alter the reproduction power to a lower boundary value Prmin₂ wherein an error rate concerned is not more than a given prescribed value (=20). Thereafter a predetermined value N (a power for a predetermined number of steps) is added to the reproduction power to thereby determine an optimum reproduction power P₂.

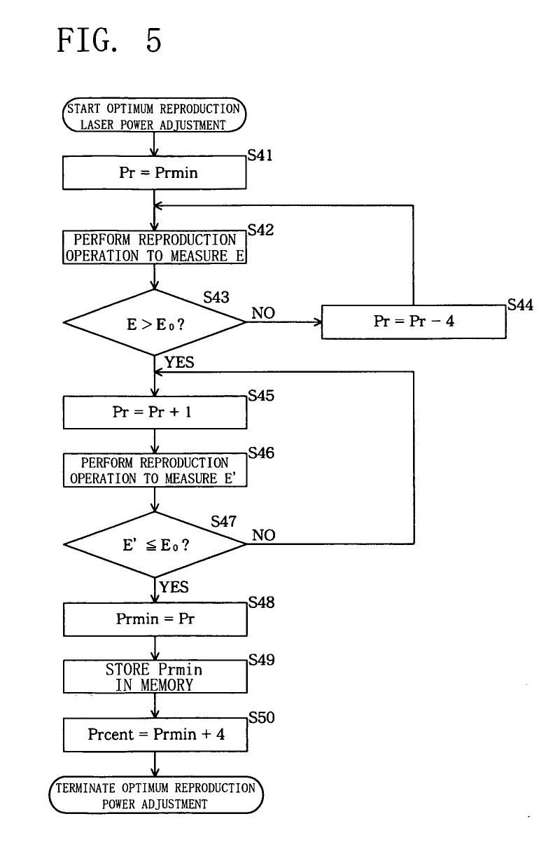

FIG. 5 shows a specific procedure for the reproduction power adjustment processing executed in step S35 described above. First in step S41 a reproduction power Pr is set to the lower boundary value Prmin stored in the built-in memory. In step S42 test tracks are reproduced, and an error rate concerned E is measured. Next in step S43 an inquiry is made as to whether the measured error rate E is greater than the prescribed value E₀ (=20). When the answer is negative, step S44 follows to decrease the reproduction power Pr by four steps. Thereafter the sequence returns to step S42 to repeat the same procedure.

Thereafter when the error rate E exceeds the prescribed value E₀ and the answer for step S43 is affirmative, step S45 follows to increase the reproduction power Pr by one step. Thereafter in step S46 the test tracks are reproduced, and an error rate concerned E′ is measured. Next in step S47 an inquiry is made as to whether the measured error rate E′ is not more than the prescribed value E₀. When the answer is negative, the sequence returns to step S45 to repeat the same procedure.

When the error rate E′ falls not more than the prescribed value E₀ and the answer for step S47 is affirmative, step S48 follows to set the reproduction power concerned Pr to the lower boundary value Prmin. Finally in step S49 the lower boundary value Prmin is stored in the built-in memory, and thereafter in step S50 a value obtained by adding a power for four steps to the lower boundary power Prmin is set as an optimum reproduction power Prcent, to terminate the procedure. Consequently, reproduction and recording of signals will be continued with an optimum laser power according to a temperature of the magneto-optical disk.

In the reproduction power adjustment processing executed in signal reproduction and signal recording of a disk recording-playback device of the present invention, as shown in FIG. 7, a new lower boundary value Prmin₂ is retrieved based on a lower boundary value Prmin₁ obtained by a previous adjustment processing. Thus, because the retrieval of the new lower boundary value Prmin₂ is based on the previous value Prmin₁, which is closer to the new lower boundary value Prmin₂ than a currently set reproduction power P₁, a period of time needed for the retrieval of the lower boundary value is shortened. Therefore a period of time taken for a calculation of an optimum reproduction power is shortened, so that there is no likelihood that original reproduction operation and recording operation are affected.

The present invention is not limited to the foregoing embodiment in construction but can be modified variously within the technical scope defined in the appended claims.

For example, in the recording power adjustment processing executed in step S10 of FIG. 2 and step S36 of FIG. 4, the same process as the reproduction power adjustment processing shown in FIG. 7 can be used.

Furthermore, in the foregoing embodiment, a reproduction power having an error rate not more than a prescribed value is retrieved as a lower boundary reproduction power Prmin, but a reproduction power having an error rate not less than a prescribed value can also be retrieved as a lower boundary reproduction power.

1. A disk playback device capable of reproducing signals from a disk by irradiating the disk with a laser beam from an optical head, the disk playback device comprising a laser drive circuit capable of feeding a drive signal to the optical head and adjusting a power of the laser beam irradiated by the optical head and a control circuit for controlling operation of the laser drive circuit, wherein the control circuit comprises reproduction power optimizing means for repeatedly optimizing the power of the laser beam for signal reproduction, and the reproduction power optimizing means comprises:
evaluation data detecting means for detecting evaluation data representing quality of a signal reproduction state;
retrieving means for retrieving one boundary value of two boundary values of a reproduction power wherein the evaluation data is a prescribed value or in the vicinity of the prescribed value; and
optimum reproduction power calculating means for calculating an optimum reproduction power based on the one boundary value retrieved,
wherein the retrieving means retrieves a new boundary value based on a boundary value obtained by a previous optimizing processing.

2. A disk playback device according to claim 1, wherein the retrieving means retrieves a lower boundary value having a smaller value from the two boundary values, and the optimum reproduction power calculating means adds a predetermined value to the lower boundary value to thereby determine the optimum reproduction power.

3. A disk playback device according to claim 1 or 2, wherein the evaluation data is a frequency of occurrence of bit errors included in a reproduced signal.

4. A disk playback device according to claim 1 or 2, wherein the disk playback device comprises temperature detecting means for detecting a temperature of the disk, and the reproduction power optimizing means optimizes the reproduction power whenever the temperature of the disk varies by a predetermined temperature.
